(19) United States
(12) Patent Application Publication
(10) Pub. No.: US 2007/0281569 A1
(43) Pub. Date: Dec. 6, 2007

(54) Thermally Insulated and Moisture-Repellent Textile Structure

(76) Inventor: Ming Lai Wu, Taipei (TW)

Correspondence Address: Richard Chen, 7F., No. 122 Sung Chiang Rd., Taipei, omitted

(21) Appl. No.: 11/422,090

(22) Filed: Jun. 5, 2006

(51) Int. Cl. D03D 15/00; D04B 21/00; B32B 5/26; D04B 1/00; D04B 11/00

(52) U.S. Cl. 442/304; 442/301; 442/189; 442/318; 442/255

(57) ABSTRACT

The invention is related to a thermally insulated and moisture-repellent textile structure, consisting of 1. an inner layer (contact skin): made of moisture-absorbance and sweat-repellant ultrafine fiber; 2. a middle layer: made of thermally insulated and anti-static metal yarns combined with moisture-absorbant and sweat-repellent ultrafine fibers; 3. an outer layer: moisture-absorbant and breathable pure cotton. When such textiles are applied to apparels like underwears, sweaters or jackets, the ultrafine fibers in the inner layer can completely absorb excessive water molecules on skin surface. When these water molecules that carry body heat pass through the middle layer, through the dual functions of the metal yarns of thermal insulation and the ultrafine fibers of moisture absorbance and sweat repellency, the water molecules are completely absorbed by the outer layer of pure cotton and repelled from the body. The body heat is conserved between the middle layer and human body. Thus, when such textile is worn, besides the anti-static and anti-bacteria property of the metal yarns, body dryness and comfort can be kept at a constant body temperature. It greatly improves the textile in the effect of moisture-absorbance and sweat-repellency and thermal insulation.

### BACKGROUND OF THE INVENTION

1. Field of the Invention

The invention is related to a textile structure design, especially it is anti-static, anti-bacteria, convenient, shape-stable, flexible and thermally insulated and moisture-repellent able to keep body dry, comfortable and at a constant temperature.

2. Description of the Prior Art

Traditional 100% cotton textile has good moisture absorbance, but is not breathable, so people wearing it might be always in a moist and cool state. It is not suitable clothing for intense sports. When it is made into apparels like sweaters and jackets, although it is thermally Insulative, it is heavy and lacks mobility. Later, although blends of cotton and synthetic fibers came up to improve the heaviness and lack of mobility, they are easy to generate static charges, especially in a cold area.

With technical advancement, pure cotton textiles cannot satisfy people's needs in comfort, lightweight or thermal insulation. Therefore, new textiles of moisture absorbance, sweat repellency, waterproofing and breathability continue to show up. However, the new textiles are far less thermally insulative than textiles of pure cottons. Textiles of synthetic fibers came up partially because of the high price of 100% cotton textiles. Such textiles made of synthetic fibers are easy to get lint and are not flame-retardant. Especially in cold area, they are easy to generate static charges that make body uncomfortable and lose immunity.

To improve the usability of a product, both added value and basic function cannot be overlooked. To produce advanced textiles and meet customer's needs, it is the primary goal of the industry. To serve the general public, the inventor with many years of manufacturing experience has endlessly devoted to research and testing on “thermally Insulated and moisture-repellent textiles” that base their design on basic function.

### SUMMARY OF THE INVENTION

The primary objective of the invention is to provide a new thermally insulated and moisture-repellent textile structure. Especially, it provides excellent moisture-absorbance, thermal insulation, softness and comfort, mobility, wrinkle-free, anti-static and anti-bacteria property.

To achieve the objective, the textile design for the invention adopts tri-layer structure, including 1. inner layer (contact skin): moisture-absorbance and sweat-repellant ultrafine fiber; 2. middle layer: thermally insulated and anti-static metal yarns combined with moisture-absorbant and sweat-repellent ultrafine fibers; 3. outer layer: moisture-absorbant and breathable pure cotton. When such textiles are applied to apparels like underwears, sweaters or jackets, the ultrafine fibers in the inner layer can completely absorb excessive water molecules on skin surface. When these water molecules that carry body heat pass through the middle layer, through the metal yarns of thermal insulation and the ultrafine fibers of moisture absorbance and sweat repellency, the water molecules are completely absorbed by the outer layer of pure cotton and repelled from the body. The body heat is conserved between the middle layer and human body. Thus, when such textile is worn, besides the anti-static and anti-bacteria property of the metal yarns, body dryness and comfort can be kept at a constant body temperature. It greatly improves the textile in the effect of moisture-absorbance and sweat-repellency and thermal insulation.

To further explain the objective, features and benefits for the invention of a thermally-insulated and moisture-repellent textile structure, the following will provide detailed description.

### BRIEF DESCRIPTION OF THE DRAWINGS

FIG. 1 is a preferred embodiment for the invention.

FIG. 2 is an illustration for another preferred embodiment for the invention.

### DETAILED DESCRIPTION OF THE PREFERRED EMBODIMENT

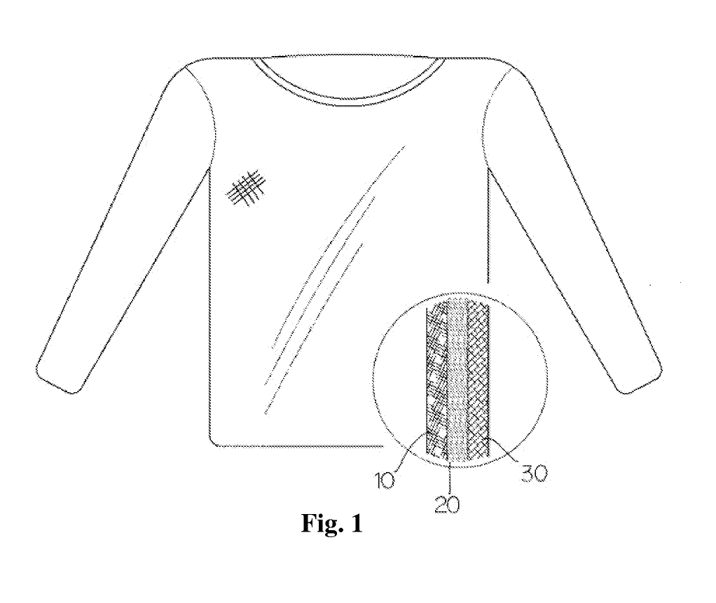

The invention provides a thermally insulated and moisture-repellent textile structure. Please refer to FIG. 1. The textile structure is composed of three layers.

An inner layer (10) is made of moisture-absorbent and sweat-repellent ultrafine fibers of 0.01 d (Denier) that deliver softness, comfort and breathability.

A middle layer (20) is made of thermally insulated and anti-static metal yarns and moisture-absorbent and sweat-repellent ultrafine fibers. The metal yarns are developed by the inventor which the metal yarns are filed down by diamond to be very thin. The metal yarns and natural fibers construct a structure that the nature fibers are wrapped by the ultrafine metal yarns. The diameter is about 0.028 mm≈0.040 mm. The strength for metal yarns is much greater than that for ordinary cotton yarns. They can improve the wear resistance of the apparels and extend their service years. Natural fibers are to provide softness and comfort.

An outer layer (30) is made of pure cottons of water-absorbance and breathability.

When the textile of the invention is applied to apparels like underwear, sweaters or jackets, the ultrafine fibers of the inner layer (10) can absorb completely the excessive water on skin surface. When these water molecules that carry body heat pass through the middle layer (20), through the metal yarns of thermal insulation and the ultrafine fibers of moisture absorbance and sweat repellency, the water molecules are completely absorbed by the outer layer (30) of pure cotton and repelled from the body. The body heat is conserved between the middle layer (20) and human body. Thus, when such textile is worn, besides the anti-static and anti-bacteria property of the metal yarns, body dryness and comfort can be kept at a constant body temperature. It greatly improves the textile in the effect of moisture-absorbance and sweat-repellency and thermal insulation.

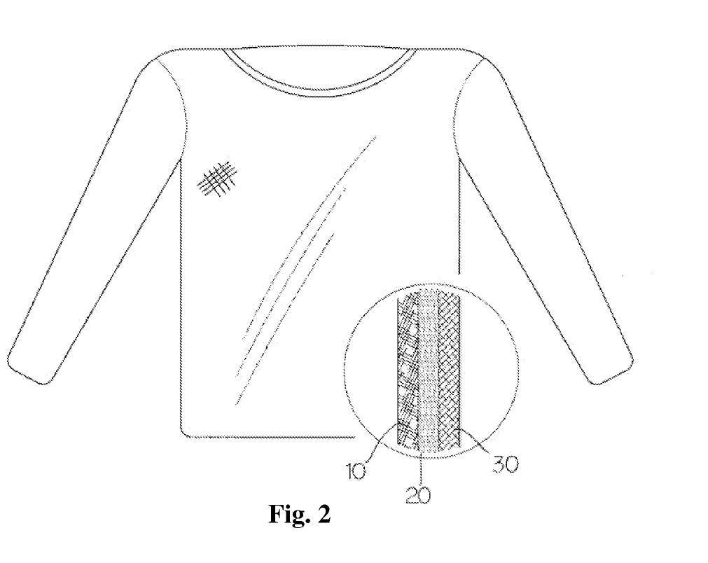

On the other hand, to make the apparels of the textiles wrinkle-free, blended fabrics are made by adding metal yarns to the outer layer (30) of pure cottons (as shown in FIG. 2). The metal yarns are harder than cotton yarns, so they offer wrinkle-free effect and aesthetic appearance.

From the above description, it is known that the thermally insulated and moisture-repellent textile structure is made of three layers. Its inner layer is composed of excellent moisture-absorbent and sweat-repellent ultrafine fibers. Its middle layer is composed of a blend of thermally insulated metal yarns and the ultrafine fibers. Its outer layer is composed of pure cottons of excellent water-absorbance. When the textiles are applied to apparels like sweaters and jackets, they do not lose mobility due to heaviness. The middle layer can effectively retain body heat and only allow water molecules to pass through. The middle layers provide body with dryness, comfort and a constant temperature. The outer layer of pure cottons provides softness and flexibility and absorbs excessive water molecules, so it also maintains dryness and comfort. On the other hand, the metal yarns especially provide flame-retardant property that completely eliminates the safety concern.

From the above description, it is clear that the textile structure of the invention provides the basic textile function in softness, comfort, lightweight and thermal insulation as well as anti-static and anti-bacteria property. Especially, it also provides moisture-absorbance, sweat-repellence (to keep body dryness and comfort) and thermal insulation (to keep body at constant temperature). All the properties of the new textile of the invention greatly exceed those for traditional textiles.

In summary, the thermally insulated and sweat-repellent textile structure after testing has proved to provide the multiple effects as mentioned above. It is considered an innovation without being published. After review of the related technical information, there is no similar design found. Accordingly, the application of patent is filed.

What is claimed is:

1. A thermally insulated and moisture-repellent textile structure consists of:
a moisture-absorbent and sweat-repellent inner layer;
a moisture-absorbent, sweat-repellent, thermally insulated and anti-static middle layer;
a water-absorbent and breathable outer layer.

2. As described in claim 1 for a thermally insulated and moisture-repellent textile structure, the inner layer is composed of superfine fibers.

3. As described in claim 1 for a thermally insulated and moisture-repellent textile structure, the middle layer is composed of metal yarns and superfine fibers.

4. As described in claim 1 for a thermally insulated and moisture-repellent textile structure, the outer layer is composed of pure cottons.

5. As described in claim 4 for a thermally insulated and moisture-repellent textile structure, the outer layer also contains metal yarns.
